(19) United States
(12) Patent Application Publication
(10) Pub. No.: US 2026/0019523 A1
(43) Pub. Date: Jan. 15, 2026

(54) IMAGE FORMING APPARATUS WITH IN-LINE SCANNER AND CONTROL METHOD THEREOF

(71) Applicant: Hewlett-Packard Development Company, L.P., Spring, TX (US)

(72) Inventors: Taehun KIM, Seongnam Si (KR); Seungyoul LEE, Seongnam Si (KR); Gyeonghun JO, Seongnam Si (KR); Jungil SEO, Seongnam Si (KR); Youngsang SEO, Seongnam Si (KR); Taehyung LEE, Seongnam Si (KR)

(21) Appl. No.: 18/994,231

(22) PCT Filed: Dec. 14, 2022
(86) PCT No.: PCT/US2022/052817

§ 371 Date: Jan. 14, 2025

(30) Foreign Application Priority Data
Jul. 18, 2022 (KR) 10-2022-0088210

(51) Int. Cl. H04N 1/44; H04N 1/00

(52) U.S. Cl. CPC H04N 1/4446; H04N 1/00803; H04N 2201/0094

(57) ABSTRACT

An example image forming apparatus includes a feed unit, an in-line scanner, and a processor. The feed unit is to feed, to the in-line scanner, a print medium on which an image is formed, the in-line scanner is to scan the fed print medium to generate a scan image, and, in response to the scan image fulfilling a condition, the processor is to control the image forming apparatus to perform an action corresponding to the condition.

### BACKGROUND

There exist many different types of image forming apparatuses, including an individual apparatus such as a dedicated printer, a scanner, a copier, a facsimile machine, etc., and also a multi-function product (MFP) that integrates the functions of the individual apparatuses as an all-in-one solution.

Printing a document via an image forming apparatus may be followed by a further action depending on a type of the document.

### BRIEF DESCRIPTION OF THE DRAWINGS

Various examples will be described below by referring to the following figures.

FIG. 1 is a diagram conceptually illustrating an image forming apparatus according to an example.

FIG. 2 is a diagram illustratively showing in-line scanning of a print medium using an in-line scanner according to an example.

FIG. 3 shows an interface through which to receive a selection of a print medium verification scheme according to an example.

FIG. 4 shows an interface through which to set a print medium verification scheme according to an example.

FIG. 5 shows an interface on which an action may be selected according to an example.

FIG. 6 shows an interface including a message that is delivered as a notification to a user according to an example.

FIG. 7 is a flow diagram illustratively showing a method for processing a print medium on which an image is formed according to an example.

FIG. 8 is a flow diagram illustratively showing operations of analyzing a print medium on which an image is formed and performing an action according to an example.

FIG. 9 is a schematic illustration of a computer readable recording medium including example instructions.

### DETAILED DESCRIPTION

Hereinafter, various examples will be described with reference to the drawings. However, the present disclosure may be implemented in several different forms and is not limited to the examples described hereinafter.

Based on a document to be printed by an image forming apparatus including sensitive information, such as personal information, confidential information, etc., that is to be carefully handled or that should not be allowed to be printed out, the printing may involve adding additional data to the to-be-printed image data. Techniques for adding the additional data include steganography, watermark, fingerprinting, and so forth. These techniques make it possible to identify, with the naked eye or with the aid of a scanner or the like, that the printed document includes information that is to be carefully handled.

As such, printing the document via the image forming apparatus may be followed by a further action depending on the type of the document. For example, based on including the sensitive information as described above, the printed document may need to be additionally examined or otherwise processed in a subsequent action. Hereinafter, this type of document may be referred to as a security document. It is to be understood that other examples of the security document are also contemplated, including many different modifications made to suit different circumstances. Based on the printed document thus corresponding to a security document, a user may obtain the printed document and carry out an additional task of examining the obtained document to perform thereon an action. For example, based on checking, with the naked eye or through the scanning function of the image forming apparatus, whether the printed document corresponds to a security document, the user may perform an additional action of deleting the data that is stored, in the image forming apparatus, for use in printing of the document, destroying the printed document, checking an identity of a user that printed out the document, or the like.

In some other examples, based on the printed document corresponding to a pay-for-print document, for example, based on the image forming apparatus being the user's personal image forming apparatus, but being used for carrying out his/her work-related print job, the user may further provide billing information regarding the print job to a specified destination, for example, his/her company, to request therefrom payment of a charge for the printed document. To this end, the user may enter, into a specified portal or the like, information used for the request, such as information regarding a total number of pages of the printed document, a scan image of the printed document, whether the printing is in color or monochrome, or the like, to provide the information to, e.g., the company. It is to be understood that a security document and a pay-for-print document are not mutually exclusive. In other words, a pay-for-print document may or may not correspond to a security document.

However, such additional task may need the user's intervention and be time-consuming and thus less convenient to take. Further, there may be missing portions in processing of the printed document, e.g., a security document or a pay-for-print document.

In accordance with some examples, a user does not need to perform further processing of a printed document, thereby providing an enhanced user experience. Further, in accordance with some examples, a security accident, an occurrence of missed billing, or the like is proactively prevented.

In an example, an image forming apparatus may include a feed unit, an in-line scanner, and a processor, wherein the feed unit is to feed to the in-line scanner a print medium on which an image is formed, wherein the in-line scanner is to scan the fed print medium to generate a scan image, and wherein, in response to the scan image fulfilling a condition, the processor is to control the image forming apparatus to perform an action corresponding to the condition. Accordingly, upon printing the image, the example image forming apparatus may scan, with the in-line scanner at that time point, the print medium on which the image is formed and based on the scan image fulfilling the condition, perform the action selected as corresponding to the condition. This may alleviate the need for the user to perform further processing of the printed document, thereby providing an enhanced user experience and proactively preventing a security accident, an occurrence of missed billing, or the like.

Various terms used in the present disclosure are chosen from a terminology of commonly used terms in consideration of their function herein, which may be appreciated differently depending on an intention, a precedent case, or an emerging new technology. In specific instances, some terms are to be construed as set forth in the detailed description. Accordingly, the terms used herein are to be defined consistently with their meanings in the context of the present disclosure, rather than simply by their plain and ordinary meaning.

The terms “comprising,” “including,” “having,” “containing,” etc. are used herein based on specifying the presence of the elements listed thereafter. Unless otherwise indicated, these terms and variations thereof are not meant to exclude the presence or addition of other elements.

As used herein, ordinal terms such as “first,” “second,” and so forth are meant to identify several similar elements. Unless otherwise specified, such terms are not intended to impose limitations, e.g., a particular order of these elements or of their use, but rather are used merely for referring to multiple elements separately. For instance, an element may be referred to in an example with the term “first” while the same element may be referred to in another example with a different ordinal number such as “second” or “third.” In such examples, such ordinal terms are not to limit the scope of the present disclosure. Also, the use of the term “and/or” in a list of multiple elements is inclusive of all possible combinations of the listed items, including any one or plurality of the items.

The term “image forming job” as used herein may encompass any of a variety of image-related jobs that involve an operation of forming an image and/or other processing operations, e.g., creation, generation, and/or transfer of an image file. The term “job” as used herein may encompass a chain of processes that facilitate an image forming job, as well as the image forming job per se. By way of example and not limitation, an image forming device may perform an image forming job, such as a print job, a copy job, a scan job, a facsimile or other transmission job, a storage job, a coating job, or the like.

The term “image forming device” or “image forming apparatus” as used herein may encompass any of a variety of devices, such as a printer, a scanner, a facsimile machine, a multi-function product (MFP), a display device, or the like, that are capable of performing an image forming job. In some examples, an image forming device may be a two-dimensional (2D) or three-dimensional (3D) image forming device. Such image forming device may provide various additional functions, as well as basic ones, for example, print, copy, and scan functions.

The term “user” as used herein may refer to a person/organization who is to manipulate an image forming device to operate an image forming job.

The term “administrator” as used herein may refer to a person/organization who has access to the entire functionality of an image forming device. By way of example and not limitation, an administrator may be a person/organization who can set up configuration data of a plurality of image forming apparatuses via a remote management server. In some examples, one person may have both roles of an administrator and a user.

The term “service provider” as used herein may refer to a person/organization who is to supply an image forming device to a user and has control of the functions and settings of the image forming device. By way of example and not limitation, a service provider may be a reseller who lends a plurality of image forming devices to a particular user or group, applies device setting values of the plurality of image forming devices according to an established contract, and controls and manages installation of an application and a setting value of the application. In some examples, one person may have both roles of an administrator and a service provider.

The terms “electronic device”, “electronic apparatus,” or “user device” as used herein may refer to any information processing device, such as, for example, a computer, a laptop, a tablet, a desktop personal computer (PC), a mobile telephone terminal, or the like, that may be used by a user.

Certain examples of the present disclosure will now be described with reference to the accompanying drawings. The present disclosure may, however, be embodied in many different forms and should not be construed as limited to the examples set forth herein. Rather, these examples are given in order to provide a better understanding of the scope of the present disclosure.

Various features of the examples will become apparent from the following detailed description taken in conjunction with the accompanying drawings.

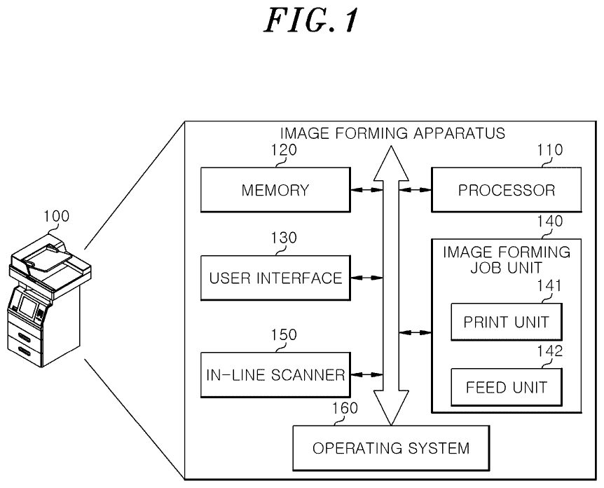

FIG. 1 is a diagram conceptually illustrating an image forming apparatus according to an example.

As shown in FIG. 1, an example image forming apparatus 100 may include a processor 110, a memory 120, a user interface 130, an image forming job unit 140, an in-line scanner 150, and an operating system 160. Other configurations of the image forming apparatus 100 are also contemplated. In an example, the image forming apparatus 100 may also include an additional component, e.g., a power supply unit to supply power to the above-mentioned components, a communications unit to communicate with external entities, or the like. In another example, the image forming apparatus 100 may include some of, but not all of, the components shown in FIG. 1. Further, it may be appreciated that the image forming apparatus 100 is not a single device but may be configured with a plurality of interconnected devices.

In some examples, the processor 110 may control a function of the image forming apparatus 100. For example, the processor 110 may be implemented with a central processing unit (CPU), a graphics processing unit (GPU), or other processing circuitry to perform the example operations described herein. For example, the processor 110 may execute an instruction stored in the memory 120. The processor 110 may also read other information stored in the memory 120. In addition, the processor 110 may store new information in the memory 120 and may update some information stored in the memory 120. For example, the processor 110 may obtain, from the memory 120, information that may be used to control the image forming apparatus 100 or may store such information in the memory 120.

In some examples, the memory 120 may include any computer-readable storage medium that stores data in a non-transitory form. Thus, the memory 120 may be implemented with Random Access Memory (RAM), Read-Only Memory (ROM), or any other suitable type of storage medium. The memory 120 may have stored therein a variety of information, for example, a set of instructions that are to be executed by the processor 110.

In some examples, the user interface 130 may provide a user of the image forming apparatus 100 with an input interface and an output interface. In an example, the user interface 130 may include a display that serves as an output interface to provide or output a status, a certain message, an installed application, or the like, of the image forming apparatus 100. In that case, the user interface 130 may be implemented as, e.g., a touch screen or other configuration. In an example, the user interface 130 may include an input interface to receive various inputs from the user. For example, the user may select his/her desired image forming job, or select among various options related to the image forming job, through such an input interface. Further, the user may launch, through the input interface, an application installed in the image forming apparatus 100. In addition, the user may use the input interface to select a scheme for verifying a print medium and to select an action to be executed based on the print medium fulfilling a certain condition. The input interface may receive and store in the memory 120 a user selection so as to be read by the processor 110. Example implementations of the input interface may include a keyboard, a keypad, a physical button, a touch pad, a touch screen, and many other types of devices that are capable of receiving a user input.

It will also be apparent that the input and the output interfaces included in the user interface 130 may be implemented as separate components or may be combined in a single component. For example, the user interface 130 may be implemented as a touch screen, which is operable both as the output interface to provide an output to the user and as the input interface to receive an input from the user.

In some examples, the image forming job unit 140 may perform an image forming job including, e.g., a print job of forming an image on a print medium such as a sheet of paper. Based on the print job being signaled to the image forming apparatus 100, the print medium may be fed from where it is loaded, for example, a print medium tray (not shown) of the image forming apparatus 100, to a print unit 141 of the image forming job unit 140. The image may be formed by the print unit 141 on the print medium. For example, the print unit 141 may include a photosensitive drum. Other examples of the print unit 141 are also contemplated. The print medium on which the image may be formed by the print unit 141 may be transferred by a feed unit 142 to an output tray (not shown). Further, the feed unit 142 may feed, to the in-line scanner 150, the print medium on which the image is formed.

The in-line scanner 150 is to scan the print medium on which the image is formed by the image forming apparatus 100. In some examples, the in-line scanner 150 may be arranged on a path along which the print medium may be transferred to the output tray after the image forming on the print medium is carried out by the image forming job unit 140. Accordingly, once fed by the feed unit 142 with the print medium on which the image is formed, the in-line scanner 150 may scan the transferred print medium to generate a scan image. That is, the in-line scanner 150 may include a device to scan, within the image forming apparatus 100 and without the need for the user's selection of a document scanning operation, the print medium on which the image is formed. The scan image generated through the scanning may be stored in, e.g., the memory 120, and used in some example operations of the image forming apparatus 100 as described below.

In some examples, the operating system 160 may provide a basic environment for control of individual hardware components of the image forming apparatus 100 and for use of application machine readable instructions/applications.

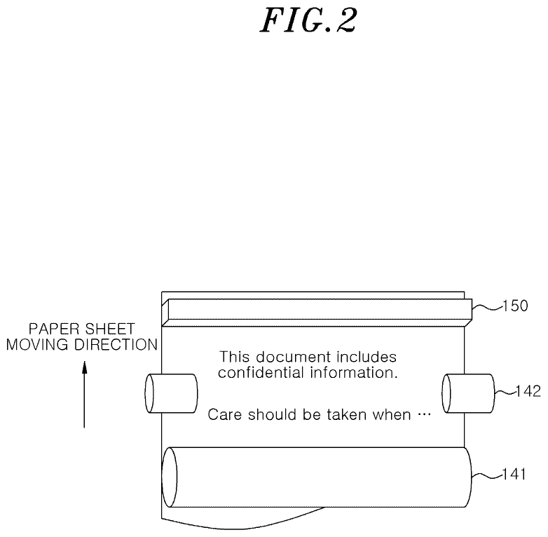

FIG. 2 is a diagram illustratively showing in-line scanning of a print medium using an in-line scanner according to an example.

Based on being signaled of a print job, the image forming apparatus 100 is to form an image on a print medium such as a sheet of paper that is fed to the print unit 141 of the image forming apparatus 100. For example, the image may be formed on the print medium as the user initiates, via an electronic device connected to the image forming apparatus, the print job to print his/her desired document. With the image formed by the print unit 141, the print medium may be transferred by the feed unit 142 along a transfer path, for example, in a direction in which the paper sheet moves as indicated in FIG. 2. This moving print medium, on which the image is formed, may be fed to and scanned by the in-line scanner 150. Through the scanning of the print medium on which the image is formed, the in-line scanner 150 may generate a scan image. The scanning operation may be carried out by the in-line scanner 150 based on the user and/or an administrator of the image forming apparatus 100 activating an in-line scan function of the image forming apparatus 100. For example, based on a print medium verification scheme being set for the image forming apparatus 100 by the user and/or administrator, the scanning function of the in-line scanner 150 may be activated so that, based on the in-line scanner 150 being fed with the print medium on which the image is formed, the processor 110 of the image forming apparatus 100 may instruct the in-line scanner 150 to scan that print medium. In another example, the image forming apparatus 100 may scan the print medium irrespective of activation of the scanning function. Other examples of the scanning function of the in-line scanner 150 are also contemplated. For example, this function may be activated/deactivated according to, e.g., a setting in an application that is implemented on the image forming apparatus 100.

As described above, with additional data added to the to-be-printed image data, the image forming apparatus 100 may print out the image. The additional data may indicate that the printout, i.e., the print medium on which the image is formed, is a document that satisfies a particular condition. By way of example, the particular condition may include a condition that the printed document is a security document containing sensitive information, such as a printed material containing personal information, confidential information, or any other type of information that is not allowed to be printed out, and/or a pay-for-print document to be billed. It is to be understood that a security document and a pay-for-print document are not mutually exclusive. For example, a pay-for-print document may or may not correspond to a security document.

In some examples, based on a user printing out an image including personal information or other type of data that should not be revealed, additional data may be added to the to-be-printed image data to allow the user to check that the printout corresponds to a security document. In addition, or instead, the printout may be produced by adding the additional data as information included to indicate that the printed material corresponds to a pay-for-print document. Example techniques of adding the additional data include schemes such as steganography, watermark, fingerprinting, pattern/text detection, or the like. Steganography is a data hiding technique and is available for incorporating, into image data, a message with changed bits to prevent a third party from using or tampering with the contained information. Watermark is a technique for inserting, in an image, a blurred image or other type of indication of its author or origin. Fingerprinting is a technique for embedding, in image data, information regarding a purchaser and thus is used for tracking the purchaser or for other purposes. There is also available a technique for detecting whether a print medium on which an image is formed includes a particular pattern or text string so that it may be checked whether the print medium on which the image is formed corresponds to a security and/or pay-for-print document. The pattern or text may be added as the additional data to the image data and formed on the print medium. Alternatively, the pattern or text may be formed prior to the forming of the image on the print medium. In such use case, the print medium may be, for example, a sheet of paper on which a company logo or a warning message is printed at a certain location.

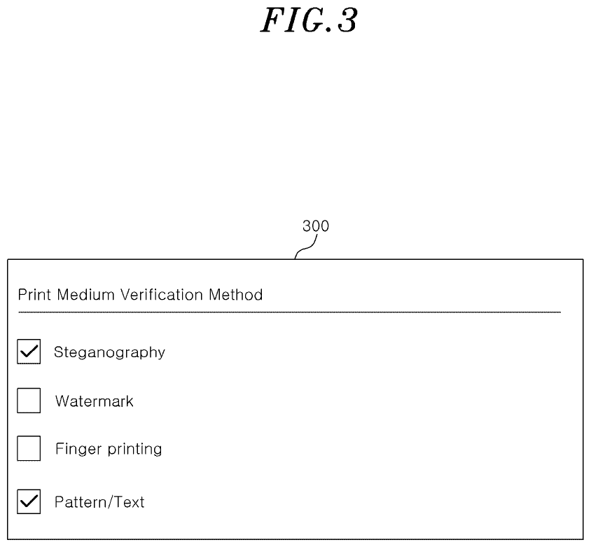

FIG. 3 shows an interface through which to receive a selection of a print medium verification scheme according to an example.

In an example, there is indicated on the user interface 130 of the image forming apparatus 100 an interface 300 through which to set a scheme of print medium verification to be performed by the image forming apparatus 100. A user and/or an administrator of the image forming apparatus, either of whom may also be referred to as the “user,” may select among schemes of print medium verification to be performed via the in-line scanner 150 on a print medium on which an image is formed. The image forming apparatus 100 may record, in the memory 120 or the like, which print medium verification scheme is selected by the user and may refer to the user-selected scheme. In another example, the interface 300 may be indicated on another electronic device that is communicatively coupled with the image forming apparatus 100 so that the user selection may be sent to and received by the image forming apparatus 100. In other examples, different implementations are possible. Further, the image forming apparatus 100 may have a default setting that specifies which of the print medium verification schemes may be used without the user's explicit selection of any of the schemes.

There may be included more than one of the print medium verification schemes. For example, the user may select among print medium verification schemes including steganography, watermark, fingerprinting, and pattern/text detection schemes. Other example print medium verification schemes are also contemplated. Based on the user-selected print medium verification scheme(s), the image forming apparatus 100 may analyze a scan image generated by the in-line scanner 150. As such, the user may set a print medium verification scheme to be performed by the image forming apparatus 100, depending on individual circumstances, for example, in view of a performance level, a usage environment, or the like of the image forming apparatus 100.

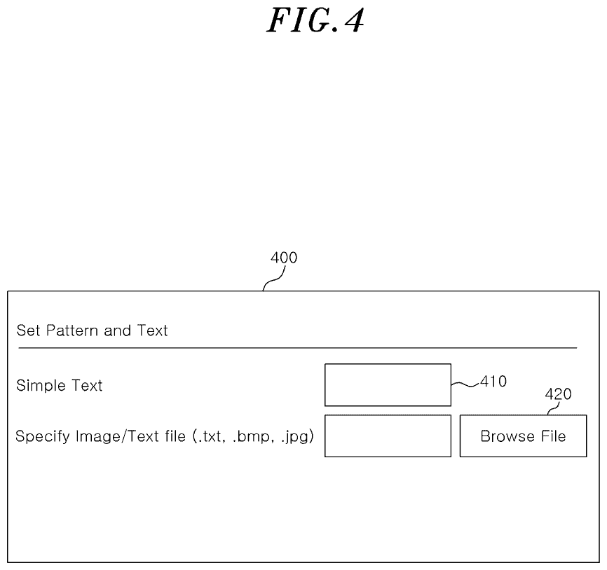

FIG. 4 shows an interface through which to set a print medium verification scheme according to an example.

As illustrated in FIG. 4, based on the user-selected print medium verification scheme being of a pattern/text detection scheme, an example user interface 400 may be used to set details thereof. The user may enter particular text in an input box 410 so that it may be detected whether the text is included in the scan image generated by the in-line scanner 150. There may also be provided a function 420 of selecting an image file containing a to-be-detected image, a text file containing to-be-detected text, or the like. For example, in order to trigger the text detection feature, the user may input simple text through the input box 410 or may input relatively longer text or hard-to-directly-enter text by selecting a text file through the function 420.

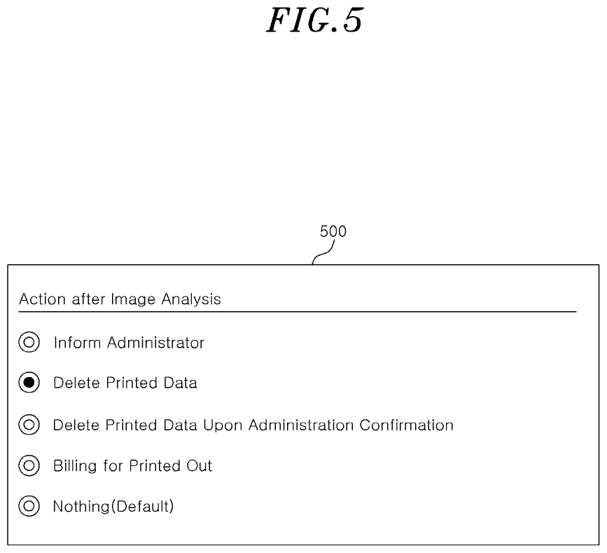

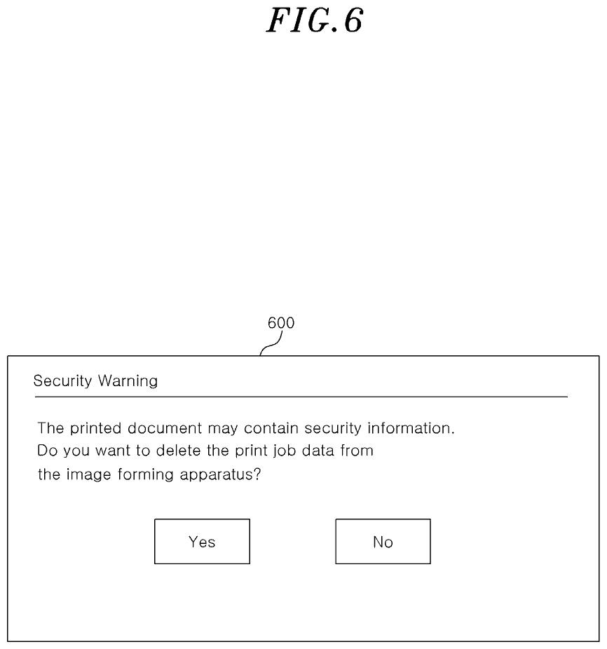

FIG. 5 shows an interface on which an action may be selected according to an example. FIG. 6 shows an interface including a message that is delivered as a notification to a user according to an example.

In various examples in which an image is formed on a print medium, based on a scan image of the print medium being analyzed as fulfilling a condition, a subsequent action may be set to be performed. For example, based on the scan image including data detected through a selected print medium verification scheme, the image forming apparatus may identify that the scan image fulfills the condition. The user may set an action to be performed corresponding to the condition based on the condition being met.

In an example, the action may include notifying a specified contact that with the condition fulfilled, the print medium is printed out via the image forming apparatus. This action may be activated based on there being made, on an example interface 500 of FIG. 5, a selection of “Inform Administrator.” For example, the notification may be provided to the administrator's preregistered e-mail address, mobile device, electronic device, or the like, or an otherwise specified destination. The contact may be set through an additional interface which is not depicted or in another manner, such as through a user device, a server, or another type of device to manage the image forming apparatus. In an example in which the scan image includes particular information, such as a specified pattern/text string, indicating that the print medium corresponds to a security document, the administrator may be notified of various information including information that the security document has been printed out via the image forming apparatus, identification information regarding the image forming apparatus from which the security document is printed out, identification information regarding what electronic device sends or who makes a request for such print job, or the like. Other examples of the information for inclusion in the notification are also contemplated. In response to the notification message, there may be signaled from the user an additional action to be performed.

In another example, the action may include permanently deleting, from the image forming apparatus, data for printing of the image, that is, print data such as a print job signaled to the image forming apparatus to form the image. This action may be activated based on there being made, on the example interface 500 of FIG. 5, a selection of “Delete Printed Data.” This deletion action may be carried out in a manner including overwriting the image data with written repetitions of a particular pattern depending on a file size of the to-be-deleted data so that the data cannot be retrieved from the memory of the image forming apparatus.

The example action of deleting the data may be set to be performed in response to the condition being fulfilled. Alternatively, the data deletion action may include querying the administrator as to whether the data is to be deleted and deleting or not deleting the data according to a response to the query. For example, this action may be activated based on there being made, on the example interface 500 of FIG. 5, a selection of “Delete Printed Data Upon Administration Confirmation.” As described above with reference to the selection of “Inform Administrator,” a registered contact may be notified that a document is printed out that fulfills the condition. This notification may include a function by which the user may select whether to delete the print data. An example message of the notification is illustrated in an example interface 600 of FIG. 6. The notified user may select deletion of the data. The device at which the notification has been received may send the user selection back to the image forming apparatus 100. In response thereto, the image forming apparatus 100 may perform the action of deleting the print data.

In still another example, the action may include performing billing for the print medium on which the image is formed. This action may be activated based on there being made, on the example interface 500 of FIG. 5, a selection of “Billing for Printed Out.” For example, based on the scan image including particular information, such as a specified pattern/text string, indicating that the print medium corresponds to a pay-for-print document, the image forming apparatus 100 may automatically perform the billing. The image forming apparatus 100 may obtain, from the information obtained from the scan image, some billing information used for the billing, for example, information regarding the number of printed sheets, whether grayscale or color printing is used, or the like. Thereafter, the image forming apparatus 100 may send the billing information through the communications unit to a specified server to register the information. The example action may provide an enhanced user experience by performing the billing in an automatic fashion, without the user's individual request for the billing, for example, even based on the image forming apparatus being a personal image forming apparatus of the user, but being used for printing out a work-related document for the user.

In yet another example, the action may include refraining from an immediate operation. This action may be activated based on there being made, on the example interface 500 of FIG. 5, a selection of “Nothing (Default).” For example, based on this action being activated, a record that a print job that fulfills the condition has been performed, together with information related to the print job, may be stored, for later checking by the user, in the memory 120 of the image forming apparatus 100, in the memory of the electronic device that has requested the print job, and/or in a server.

It may be understood that the aforementioned example actions are not mutually exclusive and may be performed in parallel. In the foregoing, the interfaces 300, 400, 500, and 600 are described as being indicated on the user interface 130 of the image forming apparatus 100 and as receiving the user's input made thereon. In some other examples, these interfaces may be indicated on another electronic device that is communicatively coupled with the image forming apparatus 100, such as the user's electronic device or mobile device, so that the user's selection made thereon may be transmitted to the image forming apparatus 100. In other examples, different implementations are possible.

The image forming apparatus 100, for example, the processor 110 of the image forming apparatus, may read out and identify a print medium verification scheme for application in analyzing a scan image of a print medium on which an image is formed, as described above. An “analysis” of a scan image refers to an operation of performing, by the processor 110 or the like, a detection or identification of whether the scan image includes particular information/data as described below. In other words, it is to be understood that the terms “analyze,” “detect,” “identify,” etc. used herein are mutually exchangeable and replaceable in the context of the present description, unless expressly stated as being mutually exclusive. In an example, based on being signaled of a print job and operating the image forming job unit 140 to perform printing accordingly, the image forming apparatus 100 may identify, from the memory 120 of the image forming apparatus 100 or the like, a print medium verification scheme to be applied to the analysis using the in-line scanner 150. The image forming apparatus 100 may analyze whether the scan image includes additional data that is detectable through the identified print medium verification scheme. In an example in which a steganography scheme is selected, it may be checked whether additional data is steganographically embedded in the print medium. In an example in which a watermark scheme is selected, it may be checked whether a to-be-identified pattern or image is contained in the print medium. In an example in which a fingerprinting scheme is selected, it may be checked whether information such as a purchaser's serial number is included in the print medium. In an example in which a pattern/text detection scheme is selected, it may be checked whether a specified pattern or text string is included in the print medium.

Based on the scan image including data detected through the selected print medium verification scheme, the image forming apparatus 100 may identify that the scan image fulfills the condition. In response to the condition being fulfilled, the image forming apparatus 100 may operate to perform, on the print medium on which the image is formed, that is, the printed-out document, an action as described above. Examples of the condition may include a condition that the print medium on which the image is formed corresponds to a security document or a condition that the print medium corresponds to a pay-for-print document. Other examples of the condition are also contemplated. It may be understood that if the user and/or administrator desires to check whether the printout is of another document type, the condition may be defined as a condition that the printout corresponds to such type of document. Further, as described above, a security document and a pay-for-print document are not mutually exclusive. In some examples, the printout may be a security and pay-for-print document. In some other examples, the printout may be a security document but not a pay-for-print document, or vice versa.

As described above, upon printing an image, an example of the image forming apparatus may generate a scan image by scanning, with the in-line scanner at that time point, a print medium on which the image is formed and, based on the scan image fulfilling a condition, perform an action that is selected as corresponding to the condition. This may alleviate the need for the user to perform further processing of the printed document, thereby providing an enhanced user experience and proactively preventing a security accident, an occurrence of missed billing, or the like.

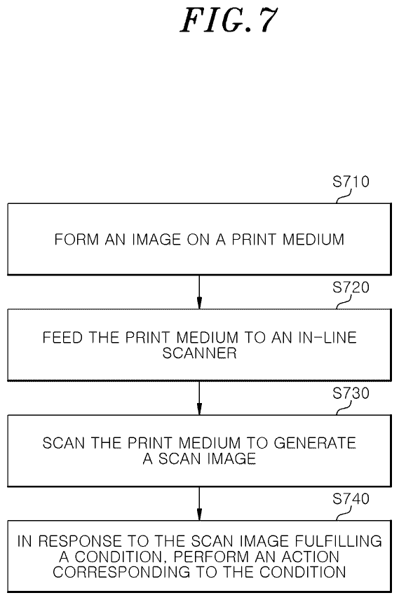

FIG. 7 is a flow diagram illustratively showing a method for processing a print medium on which an image is formed according to an example.

In an example, a method includes receiving, at operation S710, signaling of a print job to form an image on a print medium. Based on being signaled of the print job, the image forming apparatus 100 may use the print unit 141 to form the image on the print medium in accordance with the received request for the print job. As described above, the image may be formed with additional data added thereto.

The method further includes feeding, at operation S720, to the in-line scanner 150 of the image forming apparatus 100, the print medium on which the image is formed. For example, the feed unit 142 of the image forming apparatus 100 may feed, to the in-line scanner 150, the print medium on which the image is formed.

The method further includes scanning, at operation S730, by using the in-line scanner 150, the fed print medium, that is, the print medium on which the image is formed, to generate a scan image. As such, through the scanning of the print medium on which the image is formed, the in-line scanner 150 may generate a scan image. The in-line scanner 150 may perform the scanning operation based on an in-line scan function of the in-line scanner 150 being activated by a user and/or administrator of the image forming apparatus 100.

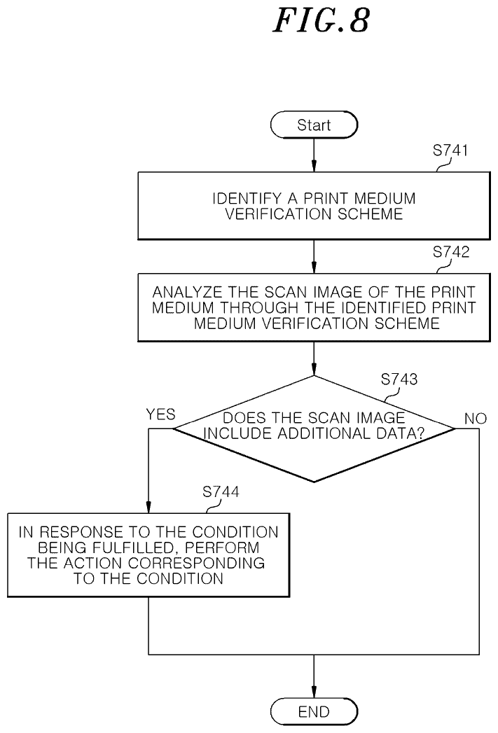

The method further includes performing, at operation S740, in response to the generated scan image fulfilling a condition, an action that corresponds to the condition. Examples thereof will be described below with reference to FIG. 8.

FIG. 8 is a flow diagram illustratively showing operations of analyzing a print medium on which an image is formed and performing an action according to an example.

In an example, the method of FIG. 7 further includes identifying, at operation S741, a print medium verification scheme for application to an analysis of the scan image. The print medium verification scheme may be set by the user and/or administrator of the image forming apparatus 100 and recorded in the memory 120 of the image forming apparatus 100. The print medium verification scheme to be applied to the analysis may include a scheme such as steganography, watermark, fingerprinting, pattern/text detection, or the like. Examples thereof are set forth above with respect to FIGS. 1 to 6 and accordingly are not repeated here.

The method further includes analyzing, at operation S742, the scan image through the identified print medium verification scheme. Other examples of the print medium verification scheme are also contemplated, in addition to the examples thereof described above, including steganography, watermark, fingerprinting, pattern/text detection, or the like.

The method further includes identifying, at operation S743, whether the scan image includes additional data that is detectable through the identified print medium verification scheme. As described above, the image forming apparatus 100 may make such identification. In an example in which a steganography scheme is selected, it may be checked whether additional data is steganographically embedded in the print medium. In an example where a watermark scheme is selected, it may be checked whether a to-be-identified pattern or image is contained in the print medium. In an example where a fingerprinting scheme is selected, it may be checked whether information such as a purchaser's serial number is included in the print medium. In an example where a pattern/text detection scheme is selected, it may be checked whether a specified pattern or text string is included in the print medium. Examples thereof are set forth above with respect to FIGS. 1 to 6 and accordingly are not repeated here.

If it is identified that the condition is fulfilled, that is, if it is identified that the scan image includes the additional data detectable through the identified verification scheme, the method proceeds to performing, at operation S744, an action that is to be carried out in correspondence with the condition. As described above, the action may include deleting, from the image forming apparatus, data for printing of the image, notifying a specified contact that the print medium is printed out, performing billing for the print medium on which the image is formed, or the like. Examples thereof are set forth above with respect to FIGS. 1 to 6 and accordingly are not repeated here.

In an example, although not shown, the method may further include receiving a selection of the print medium verification scheme to be applied to the analysis and a selection of the action to be performed in response to the condition being fulfilled. That is, the user may select, through the user interface 130 or the like, the print medium verification scheme for application in examining, with the in-line scanner 150 of the image forming apparatus 100, the print medium on which the image is formed. Further, the user may select the action to be subsequently performed if it is identified, based on the use of the in-line scanner 150 of the image forming apparatus 100 for the examination of the print medium on which the image is formed, that the print medium fulfills the condition. The image forming apparatus 100 may receive the selection of the print medium verification scheme and that of the action and may store, for example, in the memory 120, the received selections for use in performing the above-described method. In another example, the user's selection of the verification method and/or that of the action may be received from another electronic device, such as the user's electronic device, mobile device, host device, or the like, that is communicatively coupled with the image forming apparatus 100. The received user selection(s) may be sent to and received by the image forming apparatus 100. In other examples, different implementations are possible.

It is to be understood that the above-described techniques may be performed in a different order from that presented above. By way of example, the identifying at operation S741 of the print medium verification scheme may be performed in a different order as illustrated and described. Other examples of the identification followed by the analysis are also contemplated. It may also be understood that in another example, receiving from the user the selection of the print medium verification scheme to be applied to the analysis and the selection of the action to be performed in response to the condition being fulfilled may be performed in an order that is different from the order shown.

Further, examples of the condition may include a condition that the print medium on which the image is formed corresponds to a security document or a condition that the print medium corresponds to a pay-for-print document. Other examples of the condition are also contemplated. It may be understood that if the user and/or administrator desires to check whether the printout is of another document type, the condition may be defined as a condition that the printout corresponds to such type of document. Still further, a security document and a pay-for-print document are not mutually exclusive. In some examples, the printout may be a security and pay-for-print document. In some other examples, the printout may be a security document but not a pay-for-print document, or vice versa.

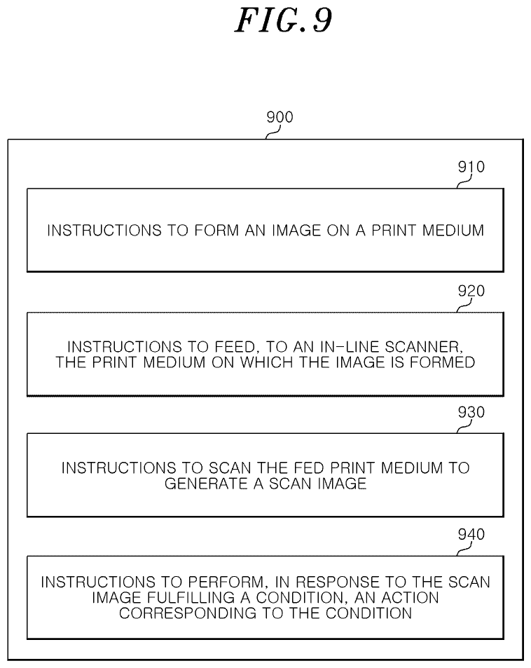

FIG. 9 is a schematic illustration of a computer readable recording medium including example instructions.

As shown in FIG. 9, a computer readable recording medium 900 stores a computer program that is executable by a processor and programmable to implement some operations of the aforementioned example methodology, such as the example operations of the image forming apparatus described above with respect to FIGS. 1 to 8 and the example operations of the method described above with respect to FIGS. 1 to 8.

The computer program on the computer readable recoding medium 900 may include a set of program instructions that direct the processor to perform specific operations. Now, with reference to FIG. 9, examples of the instructions stored in the computer readable recording medium 900 will be described.

As shown in FIG. 9, the computer program includes instructions that, based on execution by a computer, cause the computer to perform operations. The computer readable recoding medium 900 may include instructions 910 to cause the computer to form an image on a print medium, instructions 920 to cause the computer to feed, to an in-line scanner of an image forming apparatus, the print medium on which the image is formed, instructions 930 to cause the computer to scan the fed print medium to generate a scan image, and instructions 940 to cause the computer to perform, in response to the scan image fulfilling a condition, an action corresponding to the condition. The computer may include the image forming apparatus.

Although not shown, the computer program may further include instructions to cause the computer to receive a selection of a print medium verification scheme for application to an analysis of whether the scan image fulfills the condition and a selection of the action.

Although not shown, the computer program may further include instructions to cause the computer to identify the print medium verification scheme for application to the analysis of whether the scan image fulfills the condition, as well as instructions to cause the computer to analyze whether the scan image fulfills the condition, including instructions to cause the computer to identify whether the scan image includes additional data that is detectable through the identified print medium verification scheme.

As can be clearly seen, upon execution of the computer program stored in the computer readable recording medium 900, the instructions 910, 920, 930, and 940 illustrated in FIG. 9, as well as the example operations described above with respect to FIGS. 1 to 8, may be performed by the computer, for example, the above-described image forming apparatus 100.

The above-described computer readable recording medium may be a non-transitory readable medium. The term “non-transitory readable medium” as used herein refers to a medium that is capable of semi-permanently storing data and is readable by an apparatus, rather than a medium, e.g., a register, a cache, a volatile memory device, etc., that temporarily stores data. For example, the foregoing program instructions may be stored and provided in a CD, a DVD, a hard disk, a Blu-ray disc, a USB, a memory card, a ROM device, or any of other types of non-transitory readable media.

The example methodology disclosed herein may be incorporated into a computer program product. The computer program product may be available as a product for trading between a seller and a buyer. The computer program product may be distributed in the form of a machine-readable storage medium, e.g., compact disc read only memory (CD-ROM), or distributed online through an application store, e.g., PlayStore™. For the online distribution, a portion of the computer program product may be temporarily stored, or temporarily created, in a storage medium such as a server of the manufacturer, a server of the application store, a storage medium such as memory of a relay server, or the like.

The foregoing description has been presented to illustrate and describe some examples. It should be understood that many modifications and variations are possible in light of the above teaching. In various examples, suitable results may be achieved based on the above-described techniques being performed in a different order, and/or based on some of the components of the above-described systems, architectures, devices, circuits, or the like being coupled or combined in a different manner, or substituted for or replaced by other components or equivalents thereof.

Therefore, the scope of the disclosure is not to be limited to the precise form disclosed, but rather defined by the following claims and equivalents thereof.

What is claimed is:

1. An image forming apparatus, comprising:
a feed unit;
an in-line scanner; and
a processor,
wherein the feed unit is to feed to the in-line scanner a print medium on which an image is formed,
wherein the in-line scanner is to scan the fed print medium to generate a scan image, and
wherein, in response to the scan image fulfilling a condition, the processor is to control the image forming apparatus to perform an action corresponding to the condition.

2. The image forming apparatus of claim 1, wherein the image forming apparatus is to receive a selection of a print medium verification scheme for application to an analysis of whether the scan image fulfills the condition and a selection of the action.

3. The image forming apparatus of claim 2, wherein the print medium verification scheme for application to the analysis comprises steganography, watermark, fingerprinting, or pattern/text detection.

4. The image forming apparatus of claim 1, wherein the action comprises:
deleting, from the image forming apparatus, data for printing of the image;
notifying a specified contact that the print medium is printed out; or
performing billing for the print medium on which the image is formed.

5. The image forming apparatus of claim 1,
wherein the processor is to identify a print medium verification scheme for application to an analysis of whether the scan image fulfills the condition, and
wherein the analysis comprises identifying whether the scan image comprises additional data that is detectable through the identified print medium verification scheme.

6. The image forming apparatus of claim 1, wherein the condition comprises a condition that the print medium on which the image is formed corresponds to a document comprising sensitive information or a document to be billed.

7. A method for print medium processing, the method comprising:
forming an image on a print medium;
feeding, to an in-line scanner of an image forming apparatus, the print medium on which the image is formed;
scanning the fed print medium to generate a scan image; and
in response to the scan image fulfilling a condition, performing an action corresponding to the condition.

8. The method of claim 7, further comprising:
receiving a selection of a print medium verification scheme for application to an analysis of whether the scan image fulfills the condition and a selection of the action.

9. The method of claim 8, wherein the print medium verification scheme for application to the analysis comprises steganography, watermark, fingerprinting, or pattern/text detection.

10. The method of claim 7, wherein the action comprises:
deleting, from the image forming apparatus, data for printing of the image;
notifying a specified contact that the print medium is printed out; or
performing billing for the print medium on which the image is formed.

11. The method of claim 7, further comprising:
identifying a print medium verification scheme for application to an analysis of whether the scan image fulfills the condition, wherein the analysis comprises identifying whether the scan image comprises additional data that is detectable through the identified print medium verification scheme.

12. The method of claim 7, wherein the condition comprises a condition that the print medium on which the image is formed corresponds to a document comprising sensitive information or a document to be billed for.

13. A non-transitory computer readable recording medium having stored therein instructions to be executed by a processor for print medium processing of an image forming apparatus, the non-transitory computer readable recording medium comprising:
instructions to form an image on a print medium;
instructions to feed, to an in-line scanner of the image forming apparatus, the print medium on which the image is formed;
instructions to scan the fed print medium to generate a scan image; and
instructions to, in response to the scan image fulfilling a condition, perform an action corresponding to the condition.

14. The computer readable recording medium of claim 13, wherein the non-transitory computer readable recording medium further comprises:
instructions to receive a selection of a print medium verification scheme for application to an analysis of whether the scan image fulfills the condition and a selection of the action.

15. The computer readable recording medium of claim 13, wherein the non-transitory computer readable recording medium further comprises:
instructions to identify a print medium verification scheme for application to an analysis of whether the scan image fulfills the condition,
wherein the analysis comprises identifying whether the scan image comprises additional data that is detectable through the identified print medium verification scheme.
